(19) United States
(12) Patent Application Publication
(10) Pub. No.: US 2018/0106620 A1
(43) Pub. Date: Apr. 19, 2018

(54) INDOOR NAVIGATION SYSTEM AND METHOD BASED ON RELEVANCY OF ROAD SIGNS

(71) Applicant: Chen-Kuo FAN, Taipei City (TW)

(72) Inventor: Chen-Kuo FAN, Taipei City (TW)

(21) Appl. No.: 15/783,682

(22) Filed: Oct. 13, 2017

(30) Foreign Application Priority Data
Oct. 13, 2016 (TW) 105133098

(51) Int. Cl. G01C 21/20; G01C 21/34; G01C 21/36

(52) U.S. Cl. CPC G01C 21/206; G01C 21/3605; G01C 21/3453

(57) ABSTRACT

Disclosed is an indoor navigation system based on relevancy of road signs, which includes a plurality of position flags and a navigation device. The plurality of position flags are connected to one another by a plurality of roads, where the roads are assigned with a plurality road codes having continuity. Each of the plurality of position flags comprises flag information having a plurality of road codes, and a plurality of orientations associated with the plurality of road codes. The navigation device comprises a user interface, a receiver, a storage and a processor. The user interface is provided for a user to set a destination, the receiver receives the flag information of the nearest position flag, and the processor executes a navigation algorithm to obtain a direction instructing information.

### CROSS-REFERENCE TO RELATED APPLICATION

This application claims priority to Taiwan Patent Application No. 105133098, filed on Oct. 13, 2016, in the Taiwan Intellectual Property Office, the disclosure of which is incorporated herein in its entirety by reference.

### BACKGROUND OF THE INVENTION

### 1. Field of the Invention

The present invention relates to an indoor navigation system and method based on relevancy of road signs. More precisely, the present invention relates to an indoor navigation system and method, which are configured with the road codes having continuous relevance to perform orientation guide in the indoor environment without any network facility.

### 2. Description of the Related Art

The conventional navigation system generally performs position and navigation by GPS. However, the GPS system performs positioning by passively receiving a satellite signal for positioning, and thus an environment where GPS is used for position and navigation is limited to an unshielded outdoor environment in which the satellite signal may be received, if the navigation system is located in an indoor place such as a large-scale exhibition venues, a shopping mall, a hospital, a subway station, a underground street and so on, GPS may not realize position and navigation. In view of this, the passive positioning navigation systems are developed by the anecdotal companies and adapted to an environment where the satellite signal may not be received and position and navigation may not be performed by GPS.

The conventional indoor positioning navigation system generally performs triangulation positioning by using the radio wave such as Wi-Fi, etc. and thus can perform position and navigation as long as it can receive the radio wave signal from the base station, such that it is also suitable for the indoor places and is capable of supporting the indoor navigation service. However, the conventional active positioning navigation system must continuously receive the radio wave signal emitted from the base station to update position such that position and navigation may be realized result in consuming considerable power. As a result, the conventional active positioning navigation system generally faces the problem of lack of battery life and is difficult to have market competitiveness.

### SUMMARY OF THE INVENTION

In view of the above-mentioned problems, the object of the present invention is to provide an indoor navigation system based on relevancy of road signs, comprising: a plurality of position flags connected to one another by a plurality of roads, where the roads are assigned with a plurality road codes having continuity, and each of the plurality of position flags comprises flag information having a plurality of road codes of the roads connected to the position flags among the plurality of roads, and a plurality of orientations respectively associated with the plurality of road codes of the roads connected to the position flags; and a navigation device, comprising: a user interface provided for a user to set a destination associated with one of the plurality of road codes; a receiver configured to receive the flag information of one of the plurality of position flags that is nearest to the navigation device; a storage configured to store a navigation algorithm; and a processor configured to execute the navigation algorithm to obtain a direction instructing information, wherein the navigation algorithm is executed by the processor to perform at least the following step: comparing the road code associated with the destination and the received flag information to determine the road and the corresponding orientation to be traveled, so as to generate the direction instructing information.

Preferably, the plurality of road codes each has continuity based on relative positions of all the roads.

Preferably, the flag information further comprises a plurality of azimuth angle sets, each of the azimuth angle sets corresponds to a plurality of azimuth angles of the plurality of roads relative to the position flags connected to the plurality of roads, and is associated with the corresponding road code.

Preferably, the processor is configured to assign the destination set by the user with one of the plurality of road codes that is nearest to the destination to obtain a destination road code.

Preferably, each of the plurality of road codes and the destination road code comprises a horizontal sequence code and a longitudinal sequence code, and the horizontal sequential code and the longitudinal sequence code of each of the plurality of road codes that are adjacent to each other have continuity based on the relative positions of the plurality of roads.

Preferably, the navigation algorithm is executed by the processor to further perform at least the following step: comparing the horizontal sequence codes of the received flag information with the horizontal sequence code of the destination road code, and comparing the longitudinal sequence codes of the received flag information with the longitudinal sequence code of the destination road code, to determine the road and the corresponding orientation to be traveled.

Preferably, the relevancy of the plurality of orientations are related to one another based on a predetermined orientation sequence, and the navigation algorithm is performed by the processor to further compare the road code associated with the destination and the road codes associated with the received flag information according to the predetermined orientation sequence.

Another object of the present invention is to provide an indoor navigation method based on relevancy of road signs, comprising the following step: arranging a plurality of position flags connected to one another by a plurality of roads, where the roads are assigned with a plurality road codes having continuity, and each of the plurality of position flags comprises flag information having a plurality of road codes of the roads connected to the position flags among the plurality of roads, and a plurality of orientations respectively associated with the plurality of road codes of the roads connected to the position flags; receiving a destination set by a user via a user interface of a navigation device, the destination is associated with one of the plurality of road codes; receiving the flag information of one of the plurality of position flags that is nearest to the navigation device by a receiver of the navigation device; and configuring a processor of the navigation device to execute a navigation algorithm stored in a storage of the navigation device to obtain a direction instructing information, the navigation algorithm executed by the processor to perform at least the following step: comparing the road code associated with the destination and the received flag information to determining the road and the corresponding orientation to be traveled, so as to generate the direction instructing information.

Preferably, the plurality of road codes each has continuity based on the relative positions of all the roads.

Preferably, the flag information further comprises a plurality of azimuth angle sets, each of the azimuth angle sets corresponds to a plurality of azimuth angles of the plurality of roads relative to the position flags connected to the plurality of roads, and is associated with the corresponding road code.

Preferably, the processor is configured to assign the destination set by the user with one of the plurality of road codes that is nearest to the destination to obtain a destination road code.

Preferably, each of the plurality of road codes and the destination road code comprises a horizontal sequence code and a longitudinal sequence code, and the horizontal sequential code and the longitudinal sequence code of each of the plurality of road codes that are adjacent to each other have continuity based on the relative positions of the plurality of roads.

Preferably, the navigation algorithm is executed by the processor to further perform at least the following step: comparing the horizontal sequence codes of the received flag information with the horizontal sequence code of the destination road code, and comparing the longitudinal sequence codes of the received flag information with the longitudinal sequence code of the destination road code, to determine the road and the corresponding orientation to be traveled.

Preferably, the relevancy of the plurality of orientations are related to one another based on a predetermined orientation sequence, and the navigation algorithm is performed by the processor to further compare the road code associated with the destination and the road codes associated with the received flag information according to the predetermined orientation sequence.

In summary, the indoor navigation system and method based on relevancy of road signs of the present invention have the following advantages:

(1) The road layout: the road codes are designed to have continuity to significantly simplify the operation flow of the navigation algorithm.

(2) The content arrangement of the flag information: the flag information comprises the road codes, the azimuth angles, the predetermined orientation sequence and the orientation parameters such that all of the information of the intersection is provided to the navigation device in a simple manner.

(3) The navigation algorithm: the indoor navigation system and method based on relevancy of road signs of the present invention can determine and instruct a user to travel in an orientation by a simple algorithm of comparing the destination road code with the road codes having continuity in the flag information in a non-network environment. As such, not only the system resource required for operation may be saved, but also the characteristics such as energy saving and simple configuration may be achieved.

### BRIEF DESCRIPTION OF THE DRAWINGS

The aforementioned and other features and advantages of the present invention will become apparent according to the exemplary embodiments described in more detail with reference to the accompanying drawings in which:

FIG. 1 is a schematic view illustrating an embodiment of an indoor navigation system based on relevancy of road signs of the present invention.

FIGS. 2A and 2B are schematic views respectively illustrating configurations of roads and position flags of an indoor navigation system of the present invention.

FIG. 3 is a flowchart illustrating an embodiment of an algorithm of an indoor navigation system of the present invention.

FIG. 4 is a flowchart illustrating an embodiment of an indoor navigation method of the present invention.

### DETAILED DESCRIPTION OF THE PREFERRED EMBODIMENTS

To make Examiner understand the features, contents and advantages of the present invention, and the effect that may be achieved therefrom, the embodiments of the present invention are described in more detail as follows with reference to the accompanying drawings, wherein the drawings are used for the schematic purpose and providing assistance with the specification, without necessarily implying the actual ratio and the precise configuration. Therefore, in the accompanying drawings, the ratio and the configuration shall not be interpreted in any way that limits the scope of the present invention in the practice.

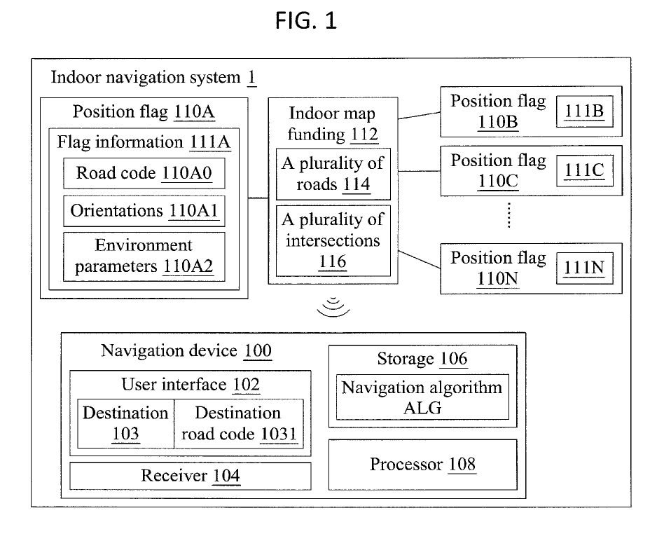

Please refer to FIG. 1, which is a schematic view illustrating an embodiment of an indoor navigation system based on relevancy of road signs of the present invention. As shown in FIG. 1, the indoor navigation system 1 of the present invention comprises a plurality of position flags 110A, 110B, 110C through 110N and a navigation device 100. First, the configurations of the plurality of position flags 110A, 110B, 110C through 110N are schematically described. The indoor map 112 of the common building comprises a plurality of roads 114 and intersections 116 connected to one another by the plurality of roads 114, and the plurality of roads 114 are assigned with a plurality of road codes 110A0 have continuity. Each of the plurality of position flags 110A, 110B, 110C through 110N comprises flag information 111A through 111N, wherein the flag information 111A of the position flag 110A comprises a plurality of road codes 110A0 of the roads connected to the position flag 110A among the plurality of roads 114, a plurality of orientations 110A1 respectively associated with the plurality of road codes 110A0 of the roads connected to the position flags 110A, and a plurality of environment parameters 110A2 respectively corresponding to the plurality of orientations. The position flags 110A through 110N may be an active emitter such as radio wave emitter, or may be a passive tag used for storing parameters required for the position flags, such as a two-dimensional bar code, a QR code, a symbol image, a sign image, a combined image of characters and numbers, or other images or characters that can be used for scanning identification. The configurations of the position flags and the road codes will be further described hereinafter.

The navigation device 100 comprises a user interface 102, a receiver 104, a storage 106 and a processor 108. The user interface 102 is provided for a user to set a destination 103 associated with one of the plurality of road codes. Here, the association between the destination 103 and the road code means that the destination 103 is directly provided for the user to select on the user interface 102, or the user may directly specify the destination 103 in the indoor map 112 displayed on the user interface 102, and the processor 108 generates a destination road code 1031 based on the destination 103, wherein the destination road code 1031 is one of the plurality of road codes corresponding to one of the plurality of roads 114 in the indoor map 112.

The receiver 104 receives the flag information of one of the plurality of position flags 110A through 110N that is nearest to the navigation device 100 (for example, when the navigation device 100 is nearest to the position flag 110A, receiving the flag information 111A). The storage 106 stores a navigation algorithm ALG, the processor 108 executes the navigation algorithm ALG to obtain a direction instructing information, the navigation algorithm ALG is executed by the processor 108 to perform the following step: comparing the road code associated with the destination 103 and the road codes associated with the received flag information, and determining the road and the corresponding orientation to be traveled, so as to generate a direction instructing information. Specifically, the navigation device 100 may be selected as a handheld device such as a tablet computer, a notebook computer or a PDA etc., or a wearable device such as a smart glasses or a smart watch etc., or other devices having scanning and communication functions.

One of the key points of the present invention is to present the roads with name. In principle, the road can be named with numbers, characters or symbols. The indoor navigation of the present invention is accomplished by using the layout of relevance between numbers and numbers, characters and characters, symbols and symbols, or combination thereof with assistance of the azimuth angle and algorithm. Specifically, the navigation system of the present invention comprises the following three parts: (1) the road layout, (2) the content planning of the position flags and (3) the navigation algorithm.

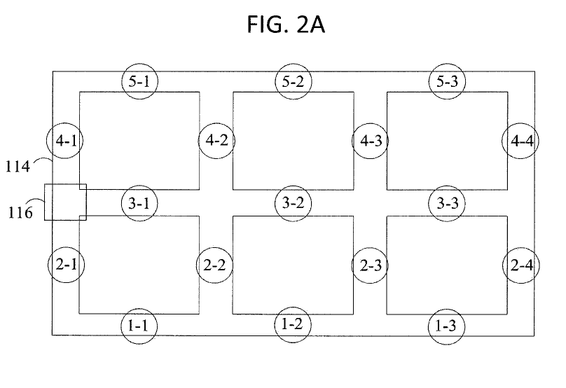

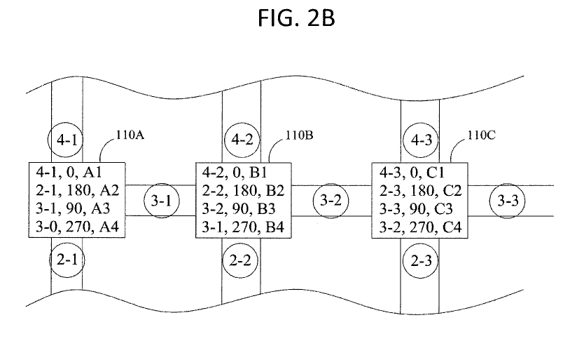

First, as will be explained with reference to FIGS. 2A and 2B, which are schematic views respectively illustrating configurations of roads and position flags of an indoor navigation system of the present invention. In order to simplify the algorithm design of the present invention, first of all, the plurality of roads of the indoor map funding as described above may be named (that is the plurality of roads are assigned with road codes) such that relevancy between the road codes are generated. For example, the road codes are assigned based on the continuity of numbers, characters or symbols according to the relative position relationship between the plurality of roads in the maps, such that the road codes have continuity. Furthermore, the starting point of the road codes can start from any of the endpoints on the map of the indoor map funding as long as relevance may be generated. For convenience of description herein, the road codes are represented by numbers and named from the lower left corner as a starting point. Also, in order to realize relevance of the numbers, naming from left to right and from bottom to top.

Wherein, the continuity can be defined mathematically. In an example described herein, the road code is encoded as Y-X, an upper road, a lower road, a right road, a left road relative to the position flag as a center are respectively marked as Y1-X1, Y2-X2, Y3-X3 and Y4-X4. Therefore, when Y1-Y2=2 and X3-X4>=1, it is determined as having continuity, or when Y1-Y2>2 and X3-X4=1, it is also determined as having continuity. Therefore, it can also use the similar codes, such as X-Y-Z, if more than three characters or numbers for naming can be seen the same continuity, it is considered that the same way is applied to create relevance. The road codes are named by using the characters to have relevance such as a, b, c . . . etc., but the computers convert the characters into the digital codes, and thus it can also be seen that the characters and the digital codes have relevance and continuity.

Each of the road codes may comprise a horizontal sequence code and a longitudinal sequence code. The horizontal sequential code and the longitudinal sequence code of each of the plurality of road codes that are adjacent to each other have continuity based on the relative positions of the plurality of roads. For example, Y-X is used for encoding as described herein, but it also can be replaced by X-Y or more other items, and not limited thereto. The first set of roads is named as a lowermost horizontal road, the leftmost road thereof is named as the road code of 1-1, and the roads extended continually to right from the leftmost road are named as the road codes of 1-2, 1-3. The second set of roads is named as a leftmost longitudinal road, the lowermost road thereof is named as 2-1 and the other longitudinal roads extended to right from the lowermost road are named as 2-2, 2-3, 2-4. In this way, the third set of roads is named as a horizontal road and the fourth set of roads is named as a longitudinal road, and the other roads are named in turn, as shown in FIG. 2A.

Next, a method of planning the flag information of the position flag of the present invention will be described with reference to FIG. 2B as an example. In short, the navigation device 100 may be informed of the current intersection and how many vicinal intersections and the direction according to the instruction of the position flags. As an example, the position flag 110B shown in the center of FIG. 2B and the content of the flag information thereof is recorded as follows:

TABLE 1

| Road code | Azimuth angle | Environment parameter |
|---|---|---|
| 4-2 | 0 | B1 |
| 2-2 | 180 | B2 |
| 3-2 | 90 | B3 |
| 3-1 | 270 | B4 |

The relevance between the plurality of orientations corresponding to each road is generated at a predetermined orientation sequence, the navigation algorithm that will be mentioned hereinafter may further compare the road code associated with the destination and the received flag information based on the predetermined orientation sequence. As shown in Table 1, the sequence of the road code is up, down, right and left. The road code above the position flag 110B is 4-2, the road code below the position flag 110B is 2-2, the road code on the right side of the position flag 110B is 3-2, and the road code on the left side of the position flag 110B is 3-1. There is no road and thus no road code on the left side of the left position flag 110A as shown in FIG. 2B, a virtual name 3-0 is given. The angles between the direction of the road code on the map (up, down, right and left) and the magnetic north pole are represented by of azimuth angles of 0, 180, 90 and 270. In the case of Table 1, the road code 2-2 is located in the south of the position flag, and an angle between the road code 2-2 and the magnetic north pole is 180 degrees. The corresponding azimuth angles of the road codes are corrected according to the environment parameters B1, B2, B3 and B4 for the environment. The aforementioned azimuth angles also may be a symbolic direction of an independent area system except for the azimuth angles of which the scientific definition (an angle between the compass and the magnetic north pole) are mentioned herein. That is, the actual azimuth angle may be “60, 150, 240, 330” and the corrected azimuth angles may be “0, 180, 90, 270” that have area symbolism. Therefore, the so-called “azimuth angle” is not limited to an angle with respect to the magnetic pole north.

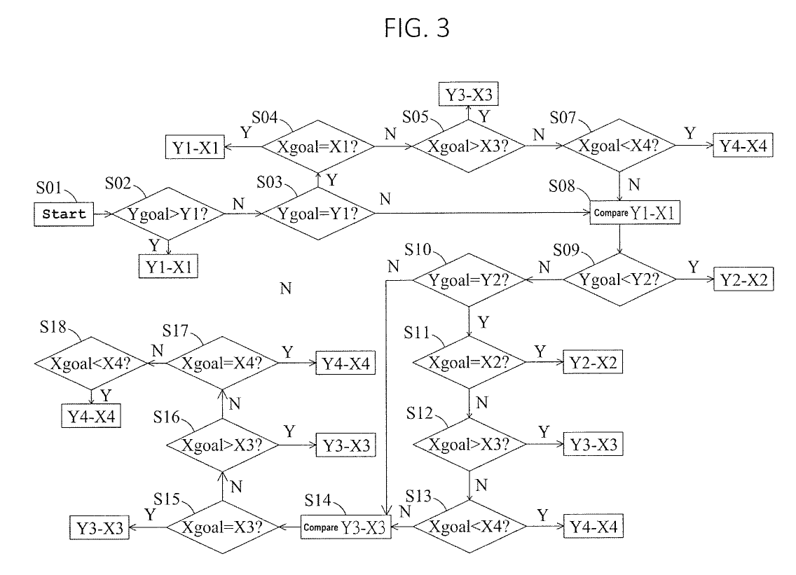

The algorithm of the indoor navigation system based on relevance of the road signs of the present invention will be described below with reference to FIG. 3, which is a flowchart illustrating an embodiment of an algorithm of an indoor navigation system of the present invention. The algorithm is not quite complex mathematical operations, and a traveling direction such as a forward, backward, left or right direction is calculated according to relevance (continuity) of the road codes. Therefore, if the road layout is not taken from bottom to top and from left to right, the algorithms are different. Alternatively, if the arrange sequence of the road codes of the position flag is different from the arrange sequence of the road codes described herein, the algorithm is different from the algorithm described herein. However, the aforementioned algorithms instructing orientation based on continuity are included within the scope of the indoor navigation system of the present invention. Even if the road layout manners are different or the arrange sequences of the road codes of the position flags are different, when the same relevance or continuity is derived from therebetween, a difference between the algorithms is only in the different sequences of comparing the information included in the road codes. It should be noted that although the plane layout of the single floor as an example in the embodiments of the present invention, the present invention is not limited thereto, and the continuous arrangement of the road codes may be further added based on the different floors such as the 1^{st} floor, the 2^{nd} floor . . . , and the road codes are arranged as Z1, Z2 . . . to be used for a comparison basis of the navigation algorithm.

The following algorithms must be in cooperation with the above layout, but the general rules of the algorithms can be applied in the different layouts as long as relevance of the numbers or characters is presented in the road codes.

First, at step S01, it is assumed that the road code of the destination is: Ygoal-Xgoal. In the case, starting at any intersection, the navigation device is informed of the relative information of Table 1 according to the position flag of the intersection, and the navigation device starts to execute the following algorithm and notify the user what direction he has to go. For the convenience of representation, the first road code on the top is called as Y1-X1, the second road code on the bottom is Y2-X2, the third road code on the right side is Y3-X3, and the fourth road code on the left side is Y4-X4.

First, comparing the first road code Y1-X1: entering the step S02, if Ygoal>Y1, turning to an azimuth angle corresponding to Y1-X1, the algorithm ends. If no, then entering the step S03. At the step S03: if Ygoal=Y1, entering the step S04, comparing X1: if Xgoal=X1, turning to an azimuth angle corresponding to Y1-X1 and reaching to a destination, the algorithm ends. If no, then entering the step S08. At the step S04, if Xgoal is not equal to X1, entering the step S05: if Xgoal>X3, turning to an azimuth angle corresponding to Y3-X3, the algorithm ends. If no, then entering the step S07: if Xgoal<X4, turning to an azimuth angle corresponding to Y4-X4, the algorithm ends. If no, then entering the step S08.

At the step S08: comparing the second road code Y2-X2. And then, entering the step S09: if Ygoal<Y2, turning to an azimuth angle corresponding to Y2-X2, the algorithm ends. If no, entering the step S10: comparing Ygoal=Y2? If yes, entering the step S11, comparing Xgoal=X2? If yes, turning to an azimuth angle corresponding to Y2-X2 and reaching the destination, the algorithm ends. At the step S10, if Ygoal is not equal to Y2, then entering the step S14, comparing the third road name Y3-X3.

If Xgoal is not equal to X2, then entering the step S12: comparing Xgoal>X3? If yes, turning to an azimuth angle corresponding to Y3-X3, the algorithm ends. If no, then entering the step S13, comparing Xgoal<X4? If yes, turning to an azimuth angle corresponding to Y4-X4, the algorithm ends. If no, then entering the step S14, comparing the third road code Y3-X3.

And then, entering the step S15, comparing Xgoal=X3? If yes, turning to an azimuth angle corresponding to Y3-X3 and reaching the destination, the algorithm ends. If no, then entering the step S16, comparing Xgoal>X3? If yes, turning to an azimuth angle corresponding to Y3-X3, the algorithm ends. If no, then entering the step S17, comparing Xgoal=X4? If yes, turning to an azimuth angle and reaching the destination, the algorithm ends. If no, then entering the step S18, comparing Xgoal<X4? If yes, obtaining and turning to an azimuth angle corresponding to Y4-X4, the algorithm ends.

The indoor navigation system of the present invention can determine and instruct the user to traveling in an orientation by the simple algorithm of comparing the road codes of the destination with the road codes have continuity in the flag information in a non-network environment based on the above road layout, content planning of the position flags and navigation algorithm. As such, it not only saves the system resource required for operation, but also can realize the characteristics such as energy saving and simple configuration.

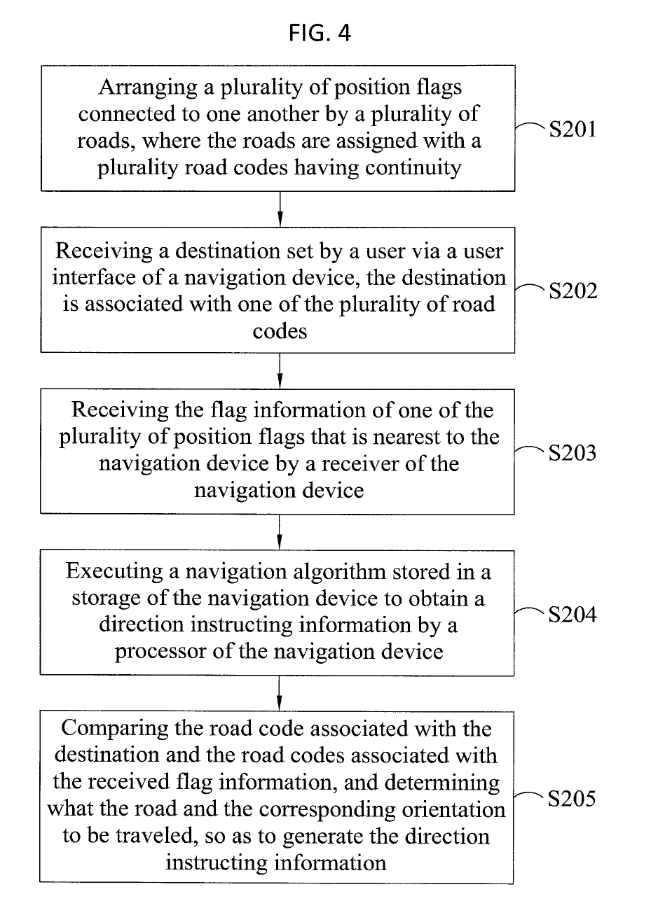

The indoor navigation method of the present invention is described below with reference to FIG. 4, which is a flowchart illustrating an embodiment of an indoor navigation method of the present invention. Wherein, the indoor navigation method of the present invention is carried out by the aforementioned indoor navigation system architecture. Therefore, the repeated description is omitted.

As shown in FIG. 4, the indoor navigation method 200 of the present invention comprises the following steps:

At the step S201: arranging a plurality of position flags connected to one another by a plurality of roads, where the roads are assigned with a plurality road codes having continuity, and each of the plurality of position flags comprises flag information having a plurality of road codes of the roads connected to the position flags among the plurality of roads, and a plurality of orientations respectively associated with the plurality of road codes of the roads connected to the position flags;

At the step S202: receiving a destination set by a user via a user interface of a navigation device, the destination is associated with one of the plurality of road codes;

At the step S203: receiving the flag information of one of the plurality of position flags that is nearest to the navigation device by a receiver of the navigation device;

At the step S204: executing a navigation algorithm stored in a storage of the navigation device to obtain a direction instructing information by a processor of the navigation device.

The navigation algorithm at the step S204 further comprises executing the following step S205: comparing the road code associated with the destination and the road codes associated with the received flag information, and determining what the road and the corresponding orientation to be traveled, so as to generate the direction instructing information. It is to be noted that the description of the exemplary flow of the navigation algorithm may further be combined with the description of FIG. 3. Therefore, the repeated description will be omitted.

In summary, the indoor navigation system and method based on relevance of road signs of the present invention have the following advantages:

(1) The road layout: the road codes are designed to have continuity to significantly simplify the operation flow of the navigation algorithm.

(2) The content planning of the flag information: the flag information comprises the road codes, the azimuth angles, the predetermined orientation sequence and the orientation parameters such that all of the information of the intersection is provided to the navigation device in a simple manner.

(3) The navigation algorithm: the indoor navigation system and method based on relevance of road signs of the present invention can determine and instruct a user to travel in an orientation by a simple algorithm of comparing the destination road code with the road codes have continuity in the flag information in a non-network environment. As such, it not only saves the system resource required for operation, but also can realize the characteristics such as energy saving and simple configuration.

The above-described embodiments merely exemplary illustrate, the present invention is not limited thereto. Any equivalent modification or change may be made thereto without departing from the scope and the spirit and scope of the present invention should be contained in the appended claims.

What is claimed is:

1. An indoor navigation system based on relevancy of road signs, comprising:
a plurality of position flags connected to one another by a plurality of roads, where the roads are assigned with a plurality road codes having continuity, and each of the plurality of position flags comprises flag information having a plurality of road codes of the roads connected to the position flags among the plurality of roads, and a plurality of orientations respectively associated with the plurality of road codes of the roads connected to the position flags; and
a navigation device, comprising:
a user interface provided for a user to set a destination associated with one of the plurality of road codes;
a receiver configured to receive the flag information of one of the plurality of position flags that is nearest to the navigation device;
a storage configured to store a navigation algorithm; and
a processor configured to execute the navigation algorithm to obtain a direction instructing information, wherein the navigation algorithm is executed by the processor to perform at least the following step:
comparing the road code associated with the destination and the received flag information to determine the road and the corresponding orientation to be traveled, so as to generate the direction instructing information.

2. The indoor navigation system of claim 1, wherein the plurality of road codes each has continuity based on relative positions of all the roads.

3. The indoor navigation system of claim 1, wherein the flag information further comprises a plurality of azimuth angle sets, each of the azimuth angle sets corresponds to a plurality of azimuth angles of the plurality of roads relative to the position flags connected to the plurality of roads, and is associated with the corresponding road code.

4. The indoor navigation system of claim 1, wherein the processor is configured to assign the destination set by the user with one of the plurality of road codes that is nearest to the destination to obtain a destination road code.

5. The indoor navigation system of claim 1, wherein each of the plurality of road codes and the destination road code comprises a horizontal sequence code and a longitudinal sequence code, and the horizontal sequential code and the longitudinal sequence code of each of the plurality of road codes that are adjacent to each other have continuity based on the relative positions of the plurality of roads.

6. The indoor navigation system of claim 5, wherein the navigation algorithm is executed by the processor to further perform at least the following step:
comparing the horizontal sequence codes of the received flag information with the horizontal sequence code of the destination road code, and comparing the longitudinal sequence codes of the received flag information with the longitudinal sequence code of the destination road code, to determine the road and the corresponding orientation to be traveled.

7. The indoor navigation system of claim 1, wherein the relevancy of the plurality of orientations are related to one another based on a predetermined orientation sequence, and the navigation algorithm is performed by the processor to further compare the road code associated with the destination and the road codes associated with the received flag information according to the predetermined orientation sequence.

8. An indoor navigation method based on relevancy of road signs, comprising the following step:
arranging a plurality of position flags connected to one another by a plurality of roads, where the roads are assigned with a plurality road codes having continuity, and each of the plurality of position flags comprises flag information having a plurality of road codes of the roads connected to the position flags among the plurality of roads, and a plurality of orientations respectively associated with the plurality of road codes of the roads connected to the position flags;
receiving a destination set by a user via a user interface of a navigation device, the destination is associated with one of the plurality of road codes;
receiving the flag information of one of the plurality of position flags that is nearest to the navigation device by a receiver of the navigation device; and
configuring a processor of the navigation device to execute a navigation algorithm stored in a storage of the navigation device to obtain a direction instructing information, the navigation algorithm executed by the processor to perform at least the following step:
comparing the road code associated with the destination and the received flag information to determining the road and the corresponding orientation to be traveled, so as to generate the direction instructing information.

9. The indoor navigation method of claim 8, wherein the plurality of road codes each has continuity based on the relative positions of all the roads.

10. The indoor navigation method of claim 8, wherein the flag information further comprises a plurality of azimuth angle sets, each of the azimuth angle sets corresponds to a plurality of azimuth angles of the plurality of roads relative to the position flags connected to the plurality of roads, and is associated with the corresponding road code.

11. The indoor navigation method of claim 8, wherein the processor is configured to assign the destination set by the user with one of the plurality of road codes that is nearest to the destination to obtain a destination road code.

12. The indoor navigation method of claim 8, wherein each of the plurality of road codes and the destination road code comprises a horizontal sequence code and a longitudinal sequence code, and the horizontal sequential code and the longitudinal sequence code of each of the plurality of road codes that are adjacent to each other have continuity based on the relative positions of the plurality of roads.

13. The indoor navigation method of claim 12, wherein the navigation algorithm is executed by the processor to further perform at least the following step:
comparing the horizontal sequence codes of the received flag information with the horizontal sequence code of the destination road code, and comparing the longitudinal sequence codes of the received flag information with the longitudinal sequence code of the destination road code, to determine the road and the corresponding orientation to be traveled.

14. The indoor navigation method of claim 8, wherein the relevancy of the plurality of orientations are related to one another based on a predetermined orientation sequence, and the navigation algorithm is performed by the processor to further compare the road code associated with the destination and the road codes associated with the received flag information according to the predetermined orientation sequence.
